(19) United States
(12) Patent Application Publication
(10) Pub. No.: US 2024/0355240 A1
(43) Pub. Date: Oct. 24, 2024

(54) CONTRAST AND COLOR COMPENSATION IN A WORLD-ADDITIVE DISPLAY FOR A HEAD MOUNTED DEVICE (HMD)

(71) Applicant: GOOGLE LLC, Mountain View, CA (US)

(72) Inventors: Stuart James Myron Nicholson, Waterloo (CA); Nils Johan Fransson, Kitchener (CA); Brian Cousins, Waterloo (CA)

(21) Appl. No.: 18/642,376

(22) Filed: Apr. 22, 2024

Related U.S. Application Data
(60) Provisional application No. 63/497,621, filed on Apr. 21, 2023.

(51) Int. Cl. G09G 3/00

(52) U.S. Cl. CPC G09G 3/001; G09G 2320/0233; G09G 2320/0242; G09G 2320/066; G09G 2360/144

(57) ABSTRACT

A system is disclosed for correcting a world-additive display of a head mounted device (HMD). The system includes a processor of a controller of the HMD connected to the world-additive display and a memory on which are stored machine-readable instructions that when executed by the processor, cause the processor to perform a process. The process includes receiving optical data from the world-additive display, receiving background data from an optical sensor connected to the controller, deriving scene estimate data from the background data, extracting display color estimate data from the optical data, generating a correction map based on the scene estimate data and the display color estimate data, and applying the correction map to the optical data. Corresponding methods and devices are also disclosed.

### CROSS REFERENCE TO RELATED APPLICATION

This application claims the benefit of U.S. Provisional Application No. 63/497,621, filed Apr. 21, 2023, the disclosure of which is incorporated herein by reference in its entirety.

### SUMMARY

One example implementation provides a system for correcting a world-additive display of a head mounted device (HMD). The system includes a processor of a controller of the HMD connected to the world-additive display; a memory on which are stored machine-readable instructions that, when executed by the processor, cause the processor to: receive optical data from the world-additive display; receive background data from an optical sensor connected to the world-additive display; derive scene estimate data from the background data; extract display color estimate data from the optical data; generate a correction map based on the scene estimate data and the display color estimate data; and apply the correction map to the optical data.

Another example implementation provides a method for correcting a world-additive display of a head mounted device (HMD) that includes one or more of: receiving, by an HMD controller, optical data from the world-additive display; receiving, by the HMD controller, background data from an optical sensor connected to the world-additive display; deriving, by the HMD controller, scene estimate data from the background data; extracting, by the HMD controller, display color estimate data from the optical data; generating a correction map based on the scene estimate data and the display color estimate data; and applying the correction map to the optical data.

A further example implementation provides a non-transitory computer readable medium including instructions, that when read by a processor, cause the processor to perform one or more of: receiving optical data from a world-additive display; receiving background data from an optical sensor connected to the world-additive display; deriving scene estimate data from the background data; extracting display color estimate data from the optical data; generating a correction map based on the scene estimate data and the display color estimate data; and applying the correction map to the optical data.

### BRIEF DESCRIPTION OF THE DRAWINGS

FIG. 1 illustrates an example network including a system for correcting a world-additive display of a head mounted device (HMD), in accordance with the disclosed implementations.

FIG. 2 illustrates an overview of a process of correcting a world-additive display of an HMD, in accordance with the disclosed implementations.

FIG. 3 illustrates a process of correcting a world-additive display of an HMD using an ambient light sensor, in accordance with the disclosed implementations.

FIG. 4 illustrates a process of correcting a world-additive display of an HMD using an ambient light sensor and pre-defined function using a content color and a background color, in accordance with the disclosed implementations.

FIG. 5 illustrates a process of correcting a world-additive display of an HMD using an optical imager for display content modification, in accordance with the disclosed implementations.

FIG. 6 illustrates a process of correcting a world-additive display of an HMD using inertial sensors and a scene reconstruction, in accordance with the disclosed implementations.

FIG. 7 illustrates an example system for correcting a world-additive display of an HMD including a detailed description of an HMD controller, in accordance with the disclosed implementations.

FIG. 8 is a flowchart of an example method for correcting a world-additive display of an HMD, in accordance with the disclosed implementations.

FIG. 9 shows an example of a generic computer device and a generic mobile computer device.

### DETAILED DESCRIPTION

A system and method for correcting a world-additive display (e.g., a display projected onto a lens) of a head mounted device (HMD) are described herein. Head-Mounted Devices (HMDs) use world-additive transparent displays projected onto the HMDs, and the contrast of these transparent displays can depend on a background (e.g., real-world background) seen through the displays. A bright background may lower the display contrast unless the display brightness is compensated (e.g., increased), and a dark background may increase the contrast unless the display brightness is compensated (e.g., decreased). If the transparent display has more than one color channel, the effective display color presented to the wearer may depend on the relative color contrast of the different color channels. In some implementations, color may be affected by the background, especially, for low contrast ratio situations. A perceived color of the transparent display may be influenced by the background.

In some implementations, a bright background (e.g., a real-world background with bright ambient lighting) that may lower the display contrast is compensated by increasing the display brightness. In some implementations, a dark background (e.g., a real-world background with little lighting) that may increase the contrast is compensated by decreasing the display brightness. In some implementations, color may be corrected in a transparent display that has more than one color channel. As discussed above, the effective display color presented to the wearer of the HMD may depend on the relative color contrast of the different color channels. In some implementations, the color of the display may be corrected according to the background.

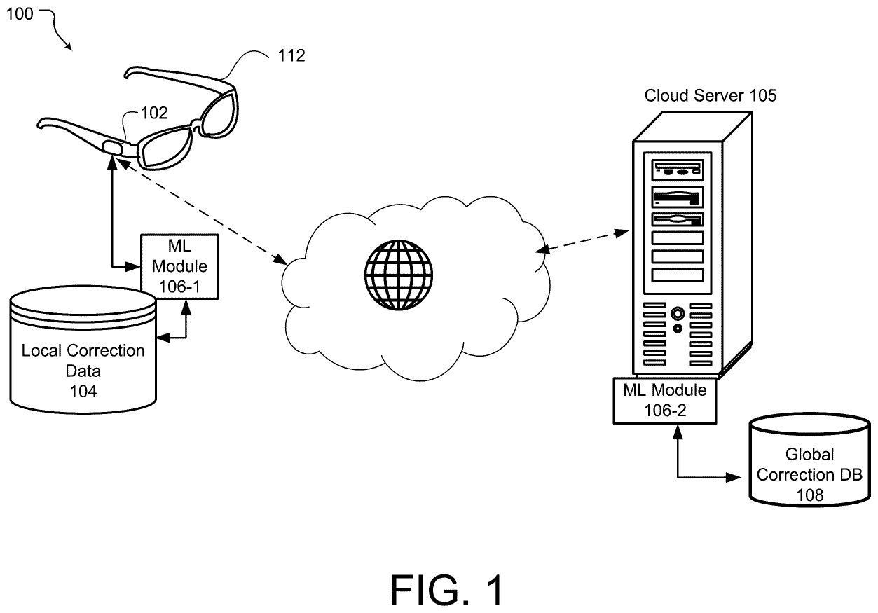

FIG. 1 illustrates example systems for correcting a world-additive display of a head mounted device (HMD), in accordance with the disclosed implementations. FIG. 1 illustrates at least two potential architectures: one including machine learning (ML) module 106-1 (e.g., a local ML module) and one including ML module 106-2 (e.g., a remote or global ML module). In some implementations, the ML module 106-1 and ML module 106-2 can be used together for processing.

An HMD in the form of smart glasses 112 may be controlled by an integrated HMD controller 102. In particular, an integrated HMD controller 102 may receive content data from a display of the smart glasses 112. The HMD controller 102 may perform color and brightness corrections of the content data (e.g., optical data) from the display of the smart glasses 112 based on ambient light data acquired from an ambient light sensor or another optical sensor (not shown).

In some implementations, the HMD controller 102 may provide the content data and/or the ambient light data to at least one of the ML modules (e.g., ML module 106-1) executing a model for determination of correction parameters for the content data. In some implementations, the ML module 106-1 may be executed by the HMD controller 102 and may use local correction data 104. In some implementations, the local correction data 104 may include pre-recorded correction parameters corresponding to certain previous ambient light data values. In some implementations, the local correction data 104 may be used by the ML module 106-1 for determination of accurate correction parameters for the current values of the content data and the ambient light data.

In some implementations, the ML module 106-2 may be implemented on a remote server 105 connected to the smart glasses 112 over a wireless network. This arrangement may allow for the ML module 106-2 to use globally collected historic correction data 108 for supervised machine learning. As an example, a variety of correction samples recorded by multiple HMDs may be aggregated by the remote server 105 and stored in the global correction database 108.

In some implementations, if the display content data received by the HMD controller 102 is not processed or recognized locally using the stored local correction data 104, the display content data may be compared with a larger pool of historic samples of the display content data along with the corresponding correction parameters. ML models generated by the ML modules 106-1 and 106-2 may include calibration using a prototype network or transfer learning.

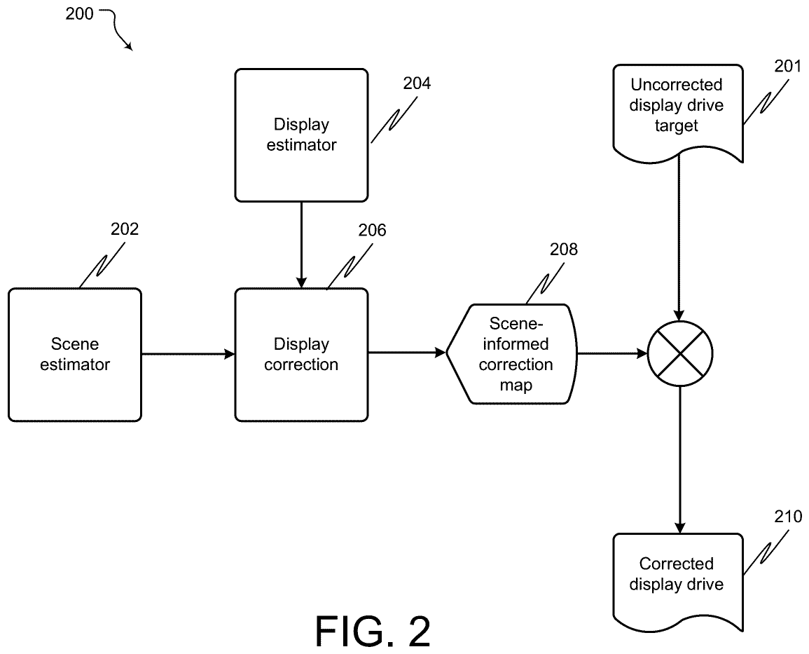

FIG. 2 illustrates an overview of a process of correcting a world-additive display of an HMD, in accordance with the disclosed implementations.

Uncorrected display drive target data 201 is received by the HMD controller 102 (see FIG. 1). This data is also referred to herein as optical data representing a display control signal. The uncorrected display drive target data 201 may be processed by a display estimator module 204 to produce color estimate data discussed in more detail below. A scene estimator module 202 may process ambient light data collected from an optical sensor to produce scene estimate data. The color estimate data and the scene estimate data may be processed by a display correction module 206 that generates a scene-informed correction map 208. The scene-informed correction map 208 may be applied to the uncorrected display drive target data 201 to produce corrected display drive data 210.

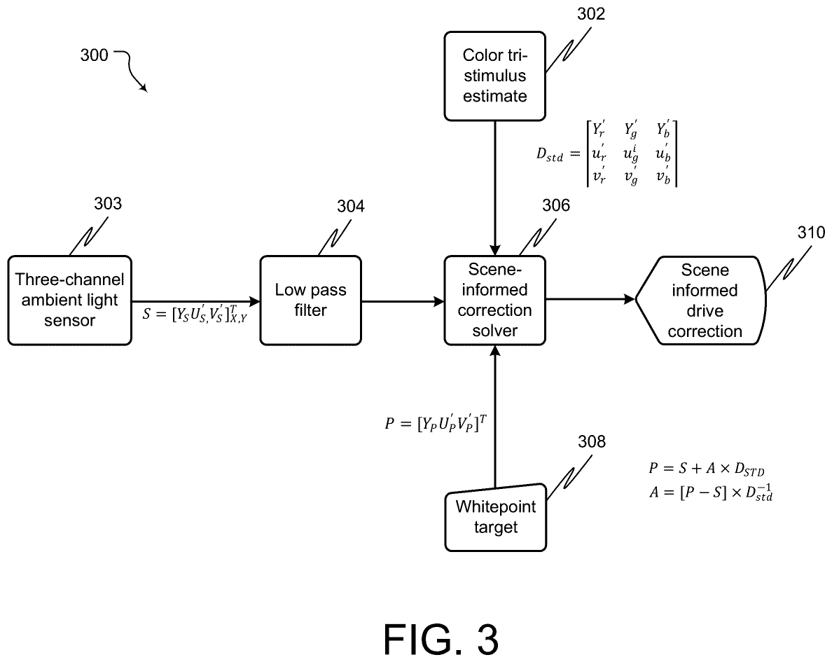

FIG. 3 illustrates a process of correcting a world-additive display of an HMD using an ambient light sensor (ALS), in accordance with the disclosed implementations.

The example process depicted in FIG. 3 reflects an implementation of a single correction for an instant in time. This process may be applicable, for example, to changing/adjusting the world-additive display of the HMD while balancing (e.g., using a white balance point) to correct for a background.

At block 302, multi-stimulus estimate data (e.g., color tri-stimulus estimate data (Dstd) in this example) may be produced from the display content data. At block 303, data(S) is acquired from a multi-channel (e.g., three-channel in this example) ambient light sensor (ALS). As shown, this data may be passed through a low-pass filter (e.g., FIR and/or IIR) at block 304. This data, along with the color tri-stimulus estimate data mentioned above and white point target data (P) from block 308, may be provided to block 306 for scene-informed correction for generation of scene-informed correction drive data (A) at block 310. Note that using this example, the estimation matrix may be extended to include the display field of view data (FOV).

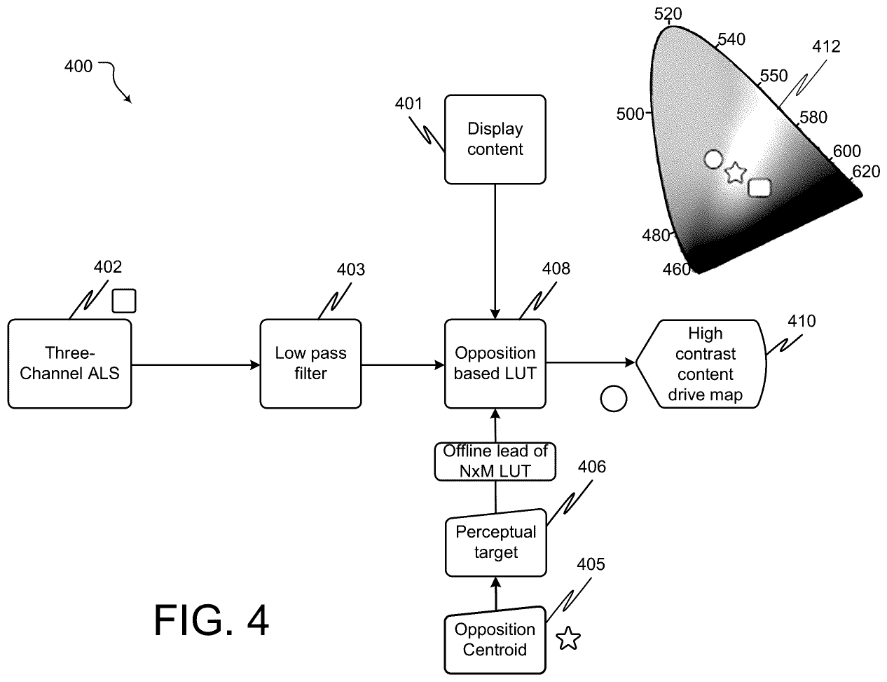

FIG. 4 illustrates a process of correcting a world-additive display of an HMD using an ambient light sensor and pre-defined function using a content color and a background color, in accordance with the disclosed implementations.

This example process illustrates an ALS-based approach where the display content data can be modified based on the pre-defined function that incorporates the display content color and/or the background color data. This process uses maximization of contrast by determining an appropriate drive by a look-up-table (LUT) and finding the “opposite color.”

For example, a color map 412 shown in FIG. 4 may represent a color map such as the CIE 1931 color space chromaticity diagram. While color is not shown in this drawing, color space chromaticity diagrams such as this are used to represent colors perceivable to the human eye. For instance, parts of the color map include various shades of red, green, blue, and many colors and shades in between. Accordingly, as shown, a circle, a star, and a rectangle are placed on the color map 412 to represent particular colors referenced elsewhere in FIG. 4 and as described in more detail below.

Display content data may be received at block 401. Background data of a particular color (indicated by the rectangle symbol mentioned above) is received from a three-channel ALS at block 402. Note that, while the ALS depicted in FIG. 4. is a three-channel ALS, a multi-channel ALS with any suitable number of channels may be used. This data may be passed through a low-pass filter at block 403 for smoothing the data by reducing local variation and removing noise. Opposition centroid color data of a particular color (represented by the star symbol mentioned above) may be acquired at block 405 to produce a perceptual target data at block 406. This data may be preloaded offline into an opposition-based lookup table (LUT) at block 408. Then, using the LUT at block 408, the data from the blocks 401 and 403 is processed to generate a high-contrast drive map 410 (corresponding to the circle symbol on the color map 412).

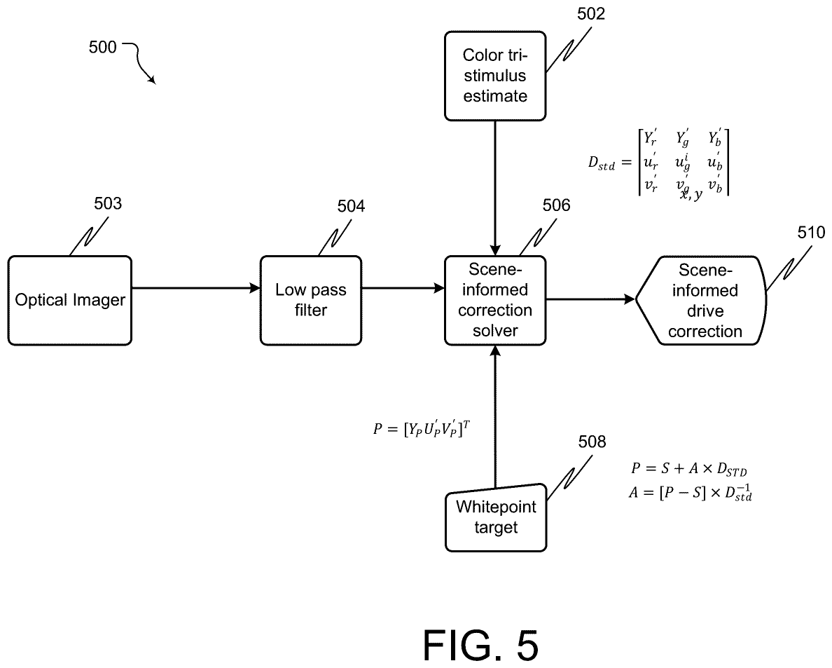

FIG. 5 illustrates a process of correcting a world-additive display of an HMD using an optical imager for display content modification, in accordance with the disclosed implementations.

The process depicted in FIG. 5 is similar to the one depicted in FIG. 3, but an optical imager is used (at block 503) in place of the ALS (of block 303). The depicted process may be applied for white balancing to correct for the background. At block 502, color tri-stimulus estimate data (Dstd) (or, as mentioned above, other multi-stimulus estimate data) may be produced from the display content data. At block 503, data(S) is acquired from an optical imager. This data is passed through a low-pass filter at block 304 to be smoothed out. Then, this data along with the color tri-stimulus estimate data and white point target data (P) from block 508 are provided to block 506 for scene-informed correction for generation of the scene-informed correction drive data (A) at block 510. Note that using this example, the estimation matrix may be extended to include the display field of view data (FOV).

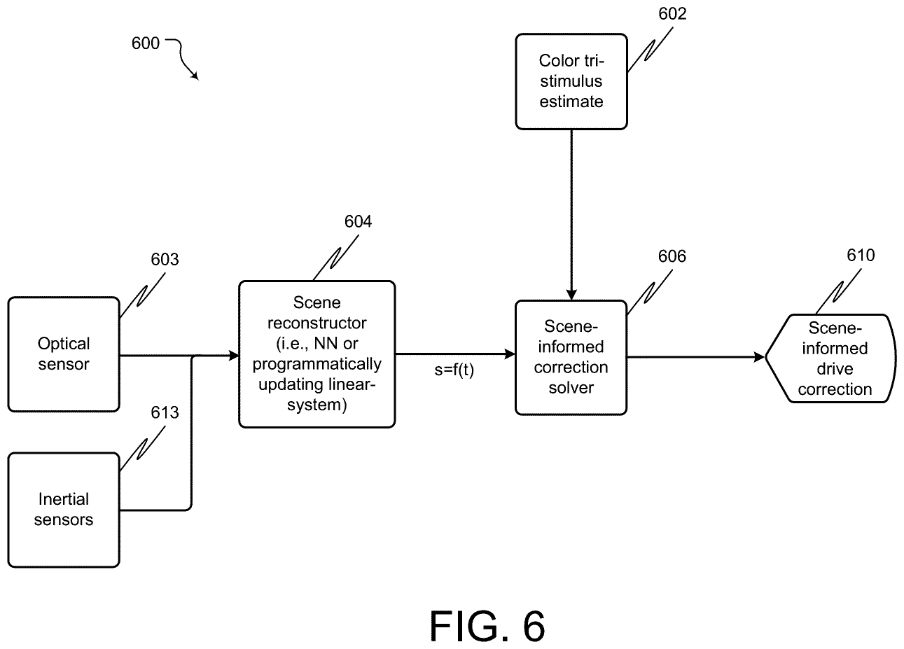

FIG. 6 illustrates a process of correcting a world-additive display of an HMD using internal sensors and a scene reconstruction, in accordance with the disclosed implementations.

In the example of a process depicted in FIG. 6, inertial sensors are used to enhance a simpler optical sensor (e.g., a one-pixel camera) with spatial selectivity and scene reconstruction capability to build the scene over time. In this example, the application may not use high resolution optical data. If a simpler optical sensor uses one pixel per color channel, the one-pixel broad spectrum brightness sensor may not be sufficient to adjust for color. In one implementation, an optical imager may be used for enhanced construction of a scene. Inertial sensors may be used to estimate positions and update a single display correction term.

At block 602, color tri-stimulus estimate data (or other multi-stimulus estimate data) may be produced from the display content data. At block 603, data is acquired from an optical sensor. This data is combined with data from the internal sensors 613 and passed through a scene reconstructor at block 604. The scene reconstruction-related data S (t) is produced over time. The S (t) is provided to block 606 for scene-informed correction for generation of the scene-informed correction drive data at block 610. In one implementation, a function that provides six-degrees-of-freedom (“6DOF”) localization or other suitable localization as an input to the scene-informed corrector and/or NN as an enhancement may be used. Note that the background data in this context represents relevant world data that may include representative background data and its pose in space relative to a user.

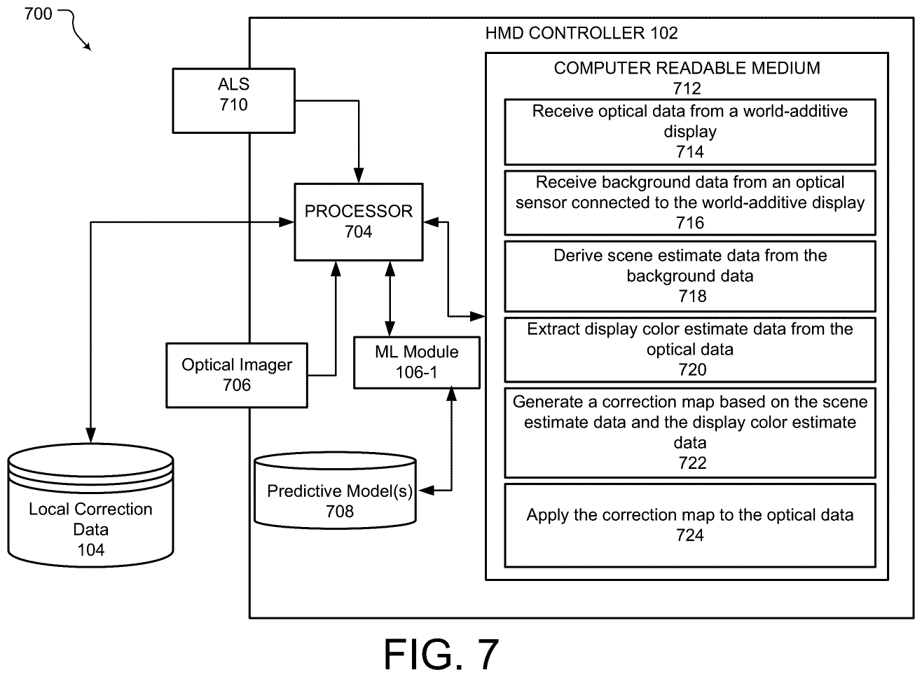

FIG. 7 illustrates an example system 700 for correcting a world-additive display of an HMD, in accordance with the disclosed implementations. As discussed above, the HMD controller 102 may be connected to an ambient light sensor 710 and to an optical imager 706 for collecting ambient light data reflecting the scene. The HMD controller 102 may have access to local correction data 104. In some implementations, the HMD controller 102 may include additional components not shown, while, in other implementations, certain components described herein may be removed and/or modified without departing from a scope of the HMD controller 102 disclosed herein. The HMD controller 102 may be implemented by a computing device and may include a processor 704, which may be a semiconductor-based microprocessor, a central processing unit (CPU), an application specific integrated circuit (ASIC), a field-programmable gate array (FPGA), and/or another suitable hardware device. Although a single processor 704 is depicted, the HMD controller 102 may include multiple processors, multiple cores, or the like, without departing from the scope of the controller 102.

The HMD controller 102 may also include a non-transitory computer readable medium 712 that may have stored thereon machine-readable instructions executable by the processor 704. Examples of the machine-readable instructions are shown as 714-724 and are further discussed below. Examples of the non-transitory computer readable medium 712 may include an electronic, magnetic, optical, or other physical storage device that contains or stores executable instructions. For example, the non-transitory computer readable medium 712 may be a Random Access Memory (RAM), an Electrically Erasable Programmable Read-Only Memory (EEPROM), a hard disk, an optical disc, or other type of storage device.

The processor 704 may execute the machine-readable instructions 714 to receive optical data from the world-additive display. The processor 704 may execute the machine-readable instructions 716 to receive background data from an optical sensor connected to the world-additive display. The processor 704 may execute the machine-readable instructions 718 to derive scene estimate data from the background data. The processor 704 may execute the machine-readable instructions 720 to extract display color estimate data from the optical data. The processor 704 may execute the machine-readable instructions 722 to generate a correction map based on the scene estimate data and the display color estimate data. The processor 704 may execute the machine-readable instructions 724 to apply the correction map to the optical data.

The processor 704 may be, or may execute, the ML module 106-1 configured to generate a predictive model 708 to determine (i.e., predict) correction parameters corresponding to the optical data received from the world-additive display (not shown) and the ambient light data received from the ALS 710 and/or the optical imager 706. The ML module 106-1 may also use predictive input data that may include white point target data, color tri-stimulus estimate data and correction lookup table (e.g., an opposition LUT).

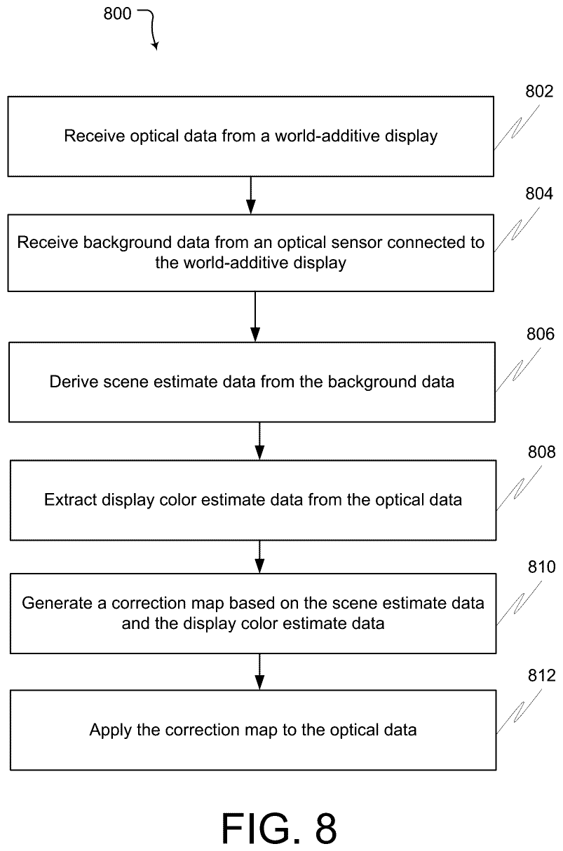

FIG. 8 is a flowchart of an example method 800 for correcting a world-additive display of an HMD, in accordance with the disclosed implementations. Referring to FIG. 8, the method 800 may include one or more of the steps described below.

FIG. 8 illustrates a flow chart of an example method executed by the HMD controller 102 (see FIG. 7). While method 800 includes certain operations in accordance with implementations described herein, it will be understood that in other implementations, method 800 may include additional, fewer, or modified operations without departing from the scope of the method 800. The description of the method 800 is also made with reference to features depicted in FIG. 7 for purposes of illustration. Particularly, the processor 704 of the HMD controller 102 may execute some or all of the operations included in the method 800.

With reference to FIG. 8, at block 802, the processor 704 may receive optical data from the world-additive display. At block 804, the processor 704 may receive background data from an optical sensor connected to the world-additive display. At block 806, the processor 704 may derive scene estimate data from the background data. At block 808, the processor 704 may extract display color estimate data from the optical data. At block 810, the processor 704 may generate a correction map based on the scene estimate data and the display color estimate data. At block 812, the processor 704 may apply the correction map to the optical data.

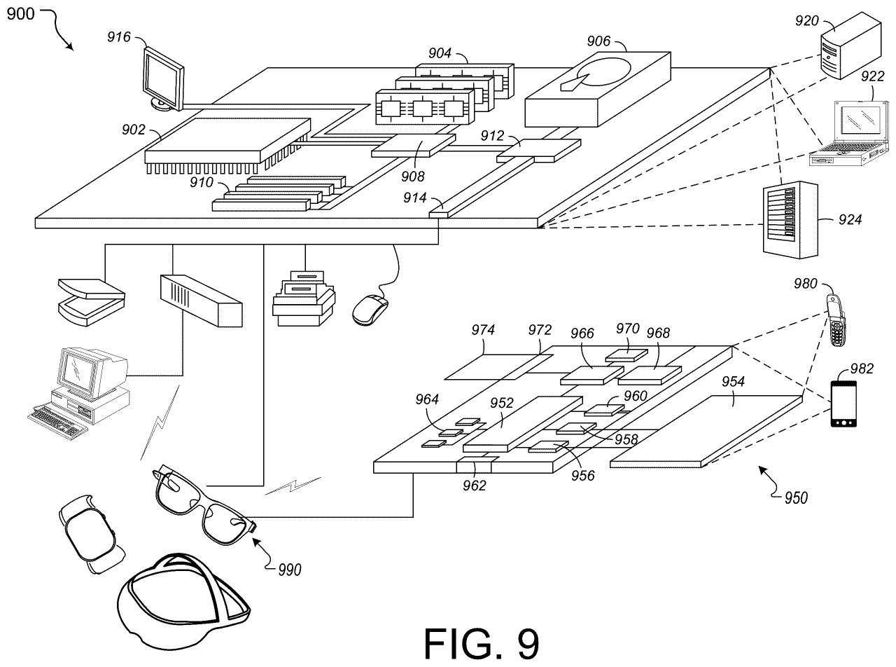

FIG. 9 shows an example of a generic computer device 900 and generic mobile computer devices 950, 990, which may be used with the techniques described herein. Computing device 900 is intended to represent various forms of digital computers, such as laptops, desktops, tablets, workstations, personal digital assistants, televisions, servers, blade servers, mainframes, and other appropriate computing devices. For example, computing device 900 may be and/or be used as the server referenced above. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device, a high-speed interface 908 connecting to memory 904 and high-speed expansion ports 910, and a low-speed interface 912 connecting to low-speed bus 914 and storage device 907. The processor 902 can be a semiconductor-based processor. The memory 904 can be a semiconductor-based memory. Each of the components 902, 904, 907, 908, 910, and 912, are interconnected using various busses, and may be mounted on a common motherboard or in other manners as appropriate. The processor 902 can process instructions for execution within the computing device 900, including instructions stored in the memory 904 or on the storage device 907 to display graphical information for a GUI on an external input/output device, such as display 916 coupled to high-speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 907 is capable of providing mass storage for the computing device 900. In one implementation, the storage device 907 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 907, or memory on processor 902.

The high-speed controller 908 manages bandwidth-intensive operations for the computing device 900, while the low-speed controller 912 manages lower bandwidth-intensive operations. Such allocation of functions is exemplary only. In one implementation, the high-speed controller 908 is coupled to memory 904, display 917 (e.g., through a graphics processor or accelerator), and to high-speed expansion ports 910, which may accept various expansion cards (not shown). In the implementation, low-speed controller 912 is coupled to storage device 907 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 977, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 974, an input/output device such as a display 954, a communication interface 977, and a transceiver 978, among other components. The device 950 may also be provided with a storage device, such as a micro-drive or other device, to provide additional storage. Each of the components 950, 952, 974, 954, 977, and 978, are interconnected using various buses, and several of the components may be mounted on a common motherboard or in other manners as appropriate.

The processor 952 can execute instructions within the computing device 950, including instructions stored in the memory 974. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 957 coupled to a display 954. The display 954 may be, for example, a TFT LCD (Thin-Film-Transistor Liquid Crystal Display) or an OLED (Organic Light Emitting Diode) display, or other appropriate display technology. The display interface 957 may comprise appropriate circuitry for driving the display 954 to present graphical and other information to a user. The control interface 958 may receive commands from a user and convert them for submission to the processor 952. In addition, an external interface 972 may be provided in communication with processor 952, so as to enable near area communication of device 950 with other devices. External interface 972 may provide, for example, for wired communication in some implementations, or for wireless communication in other implementations, and multiple interfaces may also be used.

The memory 974 stores information within the computing device 950. The memory 974 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provided as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 974, expansion memory 974, or memory on processor 952, that may be received, for example, over transceiver 978 or external interface 972.

Device 950 may communicate wirelessly through a communication interface, which may include digital signal processing circuitry where necessary. The communication interface may provide for communications under various modes or protocols, such as GSM voice calls, SMS, EMS, or MMS messaging, CDMA, TDMA, PDC, WCDMA, CDMA, or GPRS, among others. Such communication may occur, for example, through radio-frequency transceiver. In addition, short-range communication may occur, such as using a Bluetooth, WiFi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 970, which may receive spoken information from a user and convert it to usable digital information. Audio codec 970 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smartphone 982, personal digital assistant, or other similar mobile device.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described herein), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

What is claimed is:

1. A method for correcting a world-additive display of a head mounted device (HMD), the method comprising:
receiving, by an HMD controller, optical data from the world-additive display;
receiving background data from an optical sensor connected to the world-additive display;
deriving scene estimate data from the background data;
extracting display color estimate data from the optical data;
generating a correction map based on the scene estimate data and the display color estimate data; and
applying the correction map to the optical data.

2. The method of claim 1, further comprising receiving the background data from an ambient light sensor connected to the world-additive display.

3. The method of claim 2, further comprising processing the background data through a low-pass filter to derive the scene estimate data.

4. The method of claim 2, further comprising deriving multi-stimulus estimate data from the optical data.

5. The method of claim 4, further comprising generating a correction matrix based on the scene estimate data, the multi-stimulus estimate data, and opposition centroid data of the world-additive display.

6. The method of claim 5, wherein the correction matrix comprises field of view data of the world-additive display.

7. The method of claim 2, further comprising correcting contrast of the optical data based on a lookup table comprising opposite colors.

8. The method of claim 1, further comprising receiving the background data from an optical imager connected to the world-additive display;
wherein the background data is processed through a low-pass filter to derive the scene estimate data.

9. The method of claim 8, further comprising combining the background data from the optical imager with background-related data from at least one inertial sensor of the world-additive display to generate scene reconstruction data for correction of the optical data.

10. The method of claim 1, further comprising providing the scene estimate data, the display color estimate data, and opposition centroid data to a machine learning module configured to output correction parameters for the optical data.

11. A system for correcting a world-additive display of a head mounted device (HMD) comprising:
a processor of a controller of the HMD connected to the world-additive display;
a memory storing machine-readable instructions that, when executed by the processor, cause the processor to perform a process comprising:
receiving optical data from the world-additive display;
receiving background data from an optical sensor connected to the world-additive display;
deriving scene estimate data from the background data;
extracting display color estimate data from the optical data;
generating a correction map based on the scene estimate data and the display color estimate data; and
applying the correction map to the optical data.

12. The system of claim 11, wherein the process further comprises receiving the background data from an ambient light sensor connected to the world-additive display.

13. The system of claim 12, wherein the process further comprises processing the background data through a low-pass filter to derive the scene estimate data.

14. The system of claim 12, wherein the process further comprises deriving multi-stimulus estimate data from the optical data.

15. The system of claim 14, wherein:
the process further comprises generating a correction matrix based on the scene estimate data, the multi-stimulus estimate data, and opposition centroid data of the world-additive display; and
the correction matrix comprises field of view data of the world-additive display.

16. The system of claim 12, wherein the process further comprises correcting contrast of the optical data based on a lookup table comprising opposite colors.

17. The system of claim 11, wherein:
the process further comprises:
receiving the background data from an optical imager connected to the world-additive display, and
combining the background data from the optical imager with background-related data from at least one inertial sensor of the world-additive display to generate scene reconstruction data for correction of the optical data; and
the background data is processed through a low-pass filter to derive the scene estimate data.

18. The system of claim 11, wherein the process further comprises providing the scene estimate data, the display color estimate data, and opposition centroid data to a machine learning module configured to output correction parameters for the optical data.

19. A non-transitory computer-readable medium storing instructions that, when executed by a processor of a head mounted device (HMD) controller, cause the HMD controller to perform a process comprising:
receiving optical data from a world-additive display;
receiving background data from an optical sensor connected to the world-additive display;
deriving scene estimate data from the background data;
extracting display color estimate data from the optical data;
generating a correction map based on the scene estimate data and the display color estimate data; and
applying the correction map to the optical data.

20. The non-transitory computer-readable medium of claim 19, wherein the process further comprises receiving the background data from an ambient light sensor connected to the world-additive display.
